(19) United States
(12) Patent Application Publication
(10) Pub. No.: US 2007/0079930 A1
(43) Pub. Date: Apr. 12, 2007

(54) Sizable Composite Tube Bicycle Frame and Method of Making

(75) Inventor: Michael J. Parkin, Southington, CT (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: CANNONDALE BICYCLE CORPORATION, Bethel, CT (US)

(21) Appl. No.: 11/609,633

(22) Filed: Dec. 12, 2006

Related U.S. Application Data
(62) Division of application No. 10/881,910, filed on Jun. 30, 2004.

(51) Int. Cl. B32B 37/00

(52) U.S. Cl. 156/293; 264/257; 156/539

(57) ABSTRACT

A sizable reduced weight bicycle frame and method for making such incorporating tubes of a composite material, the method providing for flexibility and full customization of the bicycle frame with a minimum amount of tooling, which tooling securely holds lugs of the bicycle frame at selected customized positions relative to the tooling during the molding process.

### CROSS-REFERENCE TO RELATED APPLICATIONS

This patent application is a divisional application of U.S. patent application Ser. No. 10/881,910, entitled “Sizable Composite Tube Bicycle Frame and Method of Making”, and filed Jun. 30, 2004, the contents of which are incorporated herein by reference, in their entirety.

### FIELD OF THE INVENTION

The invention generally relates to a sizable bicycle frame including composite tubes and method for making same, and more specifically to a bicycle frame having tubes that may be fabricated from a pre-impregnated composite material that may be sized as desired to form a bicycle frame of a desired size.

### BACKGROUND OF THE INVENTION

The manufacturing and fabrication of customizable, strong and reduced weight bicycle frames provides many benefits to both the competitive and the recreational bicycler. In use, a reduced weight bicycle requires less energy to propel which can be significant during long bicycle races or on inclines.

To reduce the weight of bicycle frames composite materials have been utilized for bicycle frames in numerous different ways with limited success. For instance, U.S. Pat. Nos. 4,850,607 and 4,889,355 describe the manufacture of unitary construction bicycle frames that comprise a resin having a fibrous material provided therein such as, fiber glass, carbon fiber or Kevlar.

The interconnecting bars are first fabricated from the resin and fibrous material. Once formed to the desired length, the interconnecting bars are then placed in a common fixture that maintains their relative orientations while they are connected to each other by lugs or joints formed of additional resin and fibrous material. However, the lugs are stress points for the bicycle frame and as they comprise the resin and fibrous material, they are not strong enough to withstand the forces often encountered during aggressive or competitive cycling. In addition, customization of the bicycle frame requires the mold to be retooled and adjusted for each use according to the dimensions of the user.

Other systems have sought to provide a strong reduced weight bicycle frame including U.S. Pat. Nos. 5,803,476 and 5,876,054. Both of these patents disclose unitary composite bicycle frames comprising a single section of woven fabric, such as glass fiber, Kevlar, or carbon fiber which is impregnated with a heat curable epoxy resin. However, both of these references teach that the entire bicycle frame is molded as a unitary or composite structure with the top tube, down tube and seat tube each being connected to each other through the lugs. This process is highly undesirable because adjustability and customization of the bicycle frame is extremely difficult, time consuming and expensive because many different molds and tooling must be stocked and used to manufacture different sized bicycle frames adding to the total cost involved in the manufacturing process. In addition, the epoxy resin continuously extends as a unitary structure completely through each of the lugs which may undesirably add to the total weight of the bicycle frame.

Another approach has been to utilize bladder molds to mold carbon fiber into titanium tubes and then weld them into a frame. This process however necessitates making the tubes before they are needed and inventorying them and further limits the composite section because the tube must be fabricated first and then mitered.

Still another approach is disclosed in U.S. Pat. No. 5,158,733. In this reference a bicycle frame is disclosed in which fibers are impregnated with a heat curable synthetic resin for use with a unitary bicycle frame. In this system, a metallic unitary bicycle frame is provided with a regular pattern of holes or pieces of the metal frame removed into which holes a resin impregnated fabric is compressed, which results in a reduced weight bicycle frame being a unitary metal frame with a larger percentage (i.e. the holes) filled with a composite material. However, this is still a unitary metal bicycle frame and while the regular pattern of holes provided in the metal frame does reduce the overall weight (i.e. the metal from the holes has been removed), the frame is still too heavy because the tubes mostly comprise structural metal. In addition, as this is a unitary frame assembly, customization for a particular user requires inventorying many differing molds and tooling according to the desired dimensions of the bicycle frame based upon the size and height of the user.

What is desired then is a reduced weight bicycle frame that having lugs that will withstand the forces often encountered during aggressive or competitive cycling.

It is further desired to provide a bicycle frame that comprises a light weight composite material that is fully customizable to the individual without the need to retool for each customized frame fabricated.

It is still further desired to provide a method for fabricating a bicycle frame that utilizes the same mold for fabricating many differing sized bicycle frames.

It is yet further desired to provide a method for fabricating a bicycle frame that utilizes standard sized forms that are fully customizable without the need to stock many differing sized forms.

It is still further desired to provide a bicycle frame that comprises a light weight composite material and provides robust lugs that will not fail during use.

It is yet further desired to provide a bicycle frame utilizing a bond between the bicycle frame members and the lugs.

### BRIEF SUMMARY OF THE INVENTION

These and other objectives are achieved by the provision of the bicycle frame that utilizes a structural fiber and resin composite for the bicycle frame members or tubes including the top tube, the down tube and the seat tube, and further utilizes robust lugs or joints for joining the tubes together. The lugs may comprise for instance, a light weight durable metal or metal alloy capable of withstanding the increased stresses encountered during use.

The structural fiber and resin composite material is provided as pre-impregnated material having a standard length. This pre-impregnated material may be trimmed or cut to substantially any length desired and are positioned between the lugs. In this manner, the lugs may be positioned substantially any distance relative to each other such that many differing sized bicycle frames may be fabricated with a single mold.

The structural fiber and resin composite tubes may also be bonded with the lugs to provide a secure connection. In one advantageous embodiment the tubes are further mechanically interlocked with the lugs.

In one aspect of the invention bladder molding is utilized in the fabrication of the bicycle frame. Bladder molding also allows for a wide variety of customization of the tubing since the wall thickness of the tubes can be varied on the inner diameter, allowing both radial and circumferential butting.

In this method composite tubes are molded into lugs. Short tube sections may be welded onto the top tube and seat tube to create lugged joints. Alternatively, main tube sections may be cut out of a complete welded frame to create the lugs. The “lugs” are then arranged then arranged or positioned so that they are in the same orientation they were before the tube sections were cut apart. A pre-impregnated material of the composite material is then inserted in the lugs, being exposed in the center section of the tube and internal to the lug at the junctions. A film adhesive may be used between the pre-impregnated material and the lug to facilitate bonding. Individual molds with an internal cavity matching the lugs at the ends and the finished shape of the exposed composite tube are placed over the exposed pre-impregnated material and the composite parts are bladder molded in place. This will create a composite tubed frame without secondary bonding operations and allow flexible sizing, excellent control over tube optimization and an aesthetically pleasing design with seamless joints. While a film adhesive may be used to facilitate bonding, holes may further be cut or machined into the tubes in the overlap region of the lug and composite material such that when the composite material is heated it flows into the holes to provide a mechanical interlock between the composite and lug.

Additionally, the molds can have features for cable guides and the like, which would be nearly impossible for a conventionally manufactured tube.

A major benefit of this approach is that it allows the manufacture of small, equal length lugs for all sizes and easy varying of the composite pre-impregnated material lengths of the frame members before molding to make different frame sizes. In addition, tooling pins that hold the bicycle frame to the mold provides greater flexibility in the use of the tooling. This approach then provides a relatively lightweight composite frame with variable sizing options without requiring a relatively large tooling inventory.

In one advantageous embodiment a bicycle frame is provided comprising a first portion, a second portion, and a composite material extending between the first and second portions, the composite material sized to provide a preferred distance between the first and second portions and to size the bicycle frame. The bicycle frame further comprises an adhesive layer between an inner surface of at least the first portion and the composite material to adhere the composite material to at least the first portion.

In another advantageous embodiment a system for fabricating a bicycle frame is provided comprising a mold body having an inner molding surface, a first portion at least partially in contact with the inner molding surface, and a second portion at least partially in contact with the inner molding surface. The system further comprises an attachment device for connecting at least one of the first and second portions to one of multiple positions in the mold body to size the bicycle frame, and a composite material placed within the mold body between and within at least a part of the first and second portions.

In still another advantageous embodiment a method for manufacturing a bicycle frame is provided comprising the steps of providing a first portion, providing a second portion, and extending a composite material between the first and second portions, the composite material sized to provide a preferred distance between the first and second portions and to size the bicycle frame. The method further comprises the step of positioning an adhesive layer between an inner surface of at least the first portion and the composite material to adhere the composite material to at least the first portion.

In yet another advantageous embodiment a bicycle frame is provided comprising a first portion, a composite material at least partially inserted into the first portion, and an adhesive layer between an inner surface of the first portion and the composite material to adhere the composite material to the first portion. The bicycle frame is provided such that the composite material may be trimmed to provide a preferred length.

In still another advantageous embodiment a method for fabricating a bicycle frame is provided comprising the steps of cutting a composite material to a desired length, and inserting the composite material into an end of a first portion. The method further comprises the steps of positioning an adhesive layer between an inner surface of the first portion and the composite material, and adhering the composite material to the first portion such that the adhesive layer is sandwiched between the composite material and the inner surface of the first portion.

In yet another advantageous embodiment a system for fabricating a bicycle frame is provided comprising a mold body having an inner molding surface, a composite material placed within the mold body and at least partly within a frame portion, with the inner molding surface encasing both the composite material and at least a part of the frame portion. The system further comprises an attachment device for connecting the frame portion to one of multiple positions in the mold body to size the bicycle frame.

In still another advantageous embodiment a bicycle frame having a first portion and a second portion with a composite material extending between the first and second portions, the composite material sized to provide a preferred distance between the first and second portions and to size the bicycle frame, and having an adhesive layer between an inner surface of at least the first portion and the composite material to adhere the composite material to at least the first portion is provided. The bicycle frame is fabricated by a system comprising a mold body having an inner molding surface, where the first portion is at least partially in contact with said inner molding surface, and the second portion is at least partially in contact with said inner molding surface. The system further comprises an attachment device for connecting at least one of the first and second frame portions to one of multiple positions in the mold body to size the bicycle frame, and a composite material placed within the mold body between and within at least a part of the first and second portions.

The invention and its particular features and advantages will become more apparent form the following detailed description considered with reference to the accompanying drawings.

### BRIEF DESCRIPTION OF THE SEVERAL VIEWS OF THE DRAWINGS

FIG. 1 is an illustration of a side view of a bicycle frame according to one advantageous embodiment of the present invention;

FIG. 2 is a side view of a frame used according to one method of the present invention to fabricate the bicycle frame according to FIG. 1;

FIG. 3 is a side view of the frame of FIG. 2 illustrating the lugs;

FIG. 4 is a side view of the frame of FIG. 3 with pre-impregnated material, film adhesive and bladders inserted;

FIG. 5 is a partial exploded side view of the bicycle frame according to FIG. 1 with a mold illustrated thereabout with the tooling pins;

FIG. 6A is a side view of the frame according to FIG. 5 with the mold thereabout prior to removal;

FIG. 6B is a side view of the frame according to FIG. 5 with the mold thereabout prior to removal;

FIG. 7 is a partial enlarged view according to FIG. 4 showing an end of a pre-impregnated material in a lug and a mold;

FIG. 7A is an enlarged view according to FIG. 4 showing an end of a pre-impregnated material in a lug and a mold;

FIG. 8 is a view according to FIG. 7 showing the pre-impregnated material expanded in the mold and the lug;

FIG. 8A is a view according to FIG. 7A showing the pre-impregnated material expanded in the mold and the lug;

FIG. 9 is a view according to FIG. 8 with the mold removed therefrom;

FIG. 9A is a view according to FIG. 8A with the mold removed therefrom; and

FIG. 10 is a side view of the molds according to one advantageous embodiment for molding the bicycle frame according to FIG. 1.

### DETAILED DESCRIPTION OF THE INVENTION

Referring now to the drawings, wherein like reference numerals designate corresponding structure throughout the views.

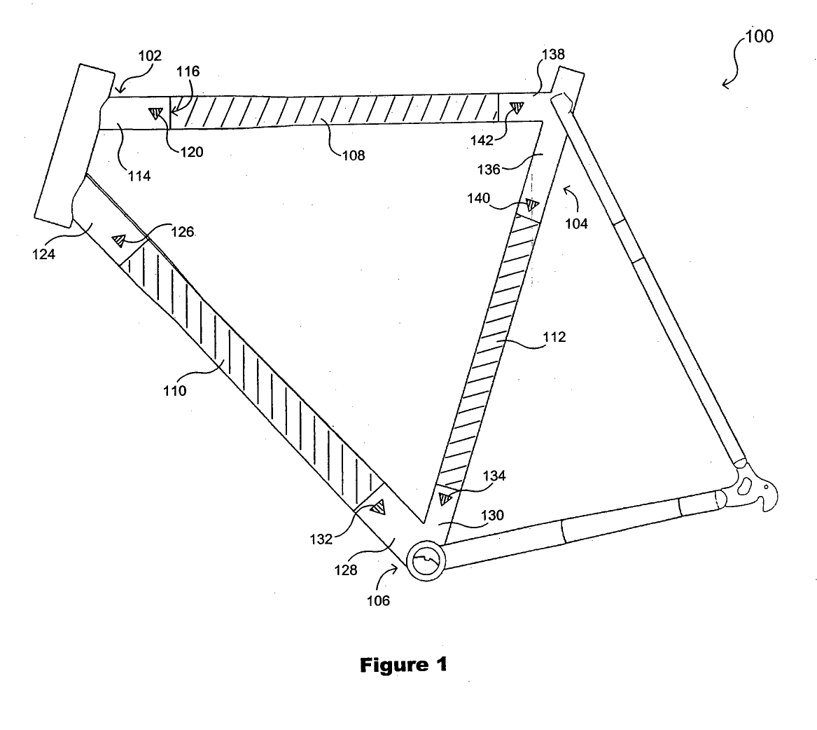

FIG. 1 is a side view of one advantageous embodiment of the present invention showing bicycle frame 100. Bicycle frame 100 generally comprises front and rear triangular sections. The front triangular section includes head lug 102, seat lug 104 and lower lug 106, which define the corners of the front triangular section. As the lugs are major stress points for bicycle frame 100, advantageously they comprise a robust material such as for instance, a metal or metal alloy.

Connecting the lugs together are tube sections. Top tube 108 connects head lug 102 to seat lug 104. Seat tube 112 connects seat lug 104 to lower lug 106. Finally, down tube 110 connects head lug 102 to lower lug 106.

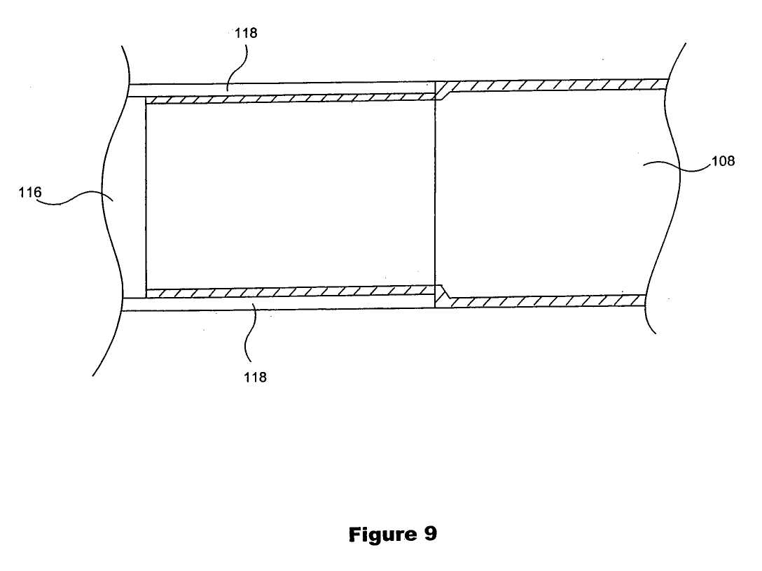

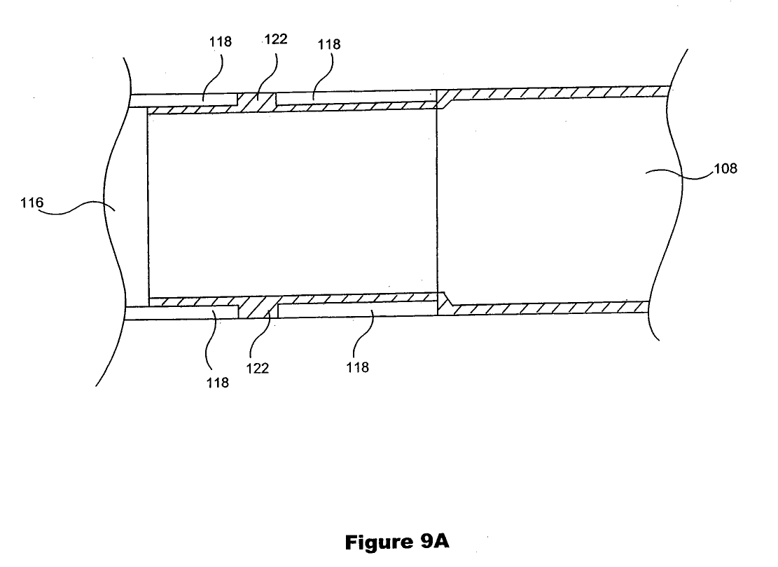

Referring now to FIG. 1 and FIG. 9 which is a cross-sectional of FIG. 1, a description of the interaction between a first portion top tube 108, and a second portion head lug 102 is provided. Head lug 102 comprises a sleeve 114 having an opening 116 into which top tube 108 is at least partially inserted with an inside diameter of sleeve 114 is defined by a perimeter wall 118.

Top tube 108 comprises two different diameters, one for the portion of top tube 108 located inside sleeve 114 and a larger diameter for the portion of top tube 108 not located inside sleeve 114. The diameter of top tube 108 outside sleeve 114 may advantageously be approximately the same as the outer diameter of sleeve 114, while the diameter of top tube 108 inside sleeve 114 is essentially the same as the inner diameter of sleeve 114.

Also provided in wall 118 is hole 120 into which protrusion 122 is positioned. The engagement of protrusion 122 with hole 120 provides a mechanical interlock between the first portion top tube 108, and the second portion head lug 102. This type of connection is highly secure as opposed to simply bonding top tube 108 to head lug 102 with for instance, an epoxy or cement which can fracture or break with the high stresses placed upon the joint.

Referring now to the additional features of bicycle frame 100 shown in FIG. 1, head lug 102 further comprises sleeve 124 and opening 126, which receives down tube 110 in a similar manner as described above. Still further, lower lug 106 comprises sleeves 128, 130 for receiving down tube 110 and seat tube 112 respectively. Lower lug further comprises holes 132, 134 for creating a mechanical interlock between lower lug 106 and down tube 110 and seat tube 112 respectively. Seat lug 104 is also illustrated in FIG. 1 comprising sleeves 136, 138 for receiving seat tube 112 and top tube 108 respectively. In addition, sleeves 136, 138 are provided with holes 140, 142 for mechanically interlocking seat tube 112 and top tube 108 to seat lug 104 respectively.

While the lugs may advantageously comprise a rugged material such as a metal or a metal alloy in order to withstand the stresses encountered at the stress points, top tube 108, down tube 110 and seat tube 112 may advantageously comprise a composite material, illustrated with diagonal cross-hatching in FIG. 1, for reducing the overall weight of the bicycle frame 100. The composite material may comprise for instance, but is not limited to a structural fiber impregnated with a heat curable resin wherein the structural fiber may comprise carbon fibers, glass fibers, polyethylene fibers, or combinations thereof. As an alternative, it is contemplated that thermoplastic composites may be utilized as desired. In any event, it is contemplated that many differing compositions may be utilized as the composite material for use in fabricating the tube sections.

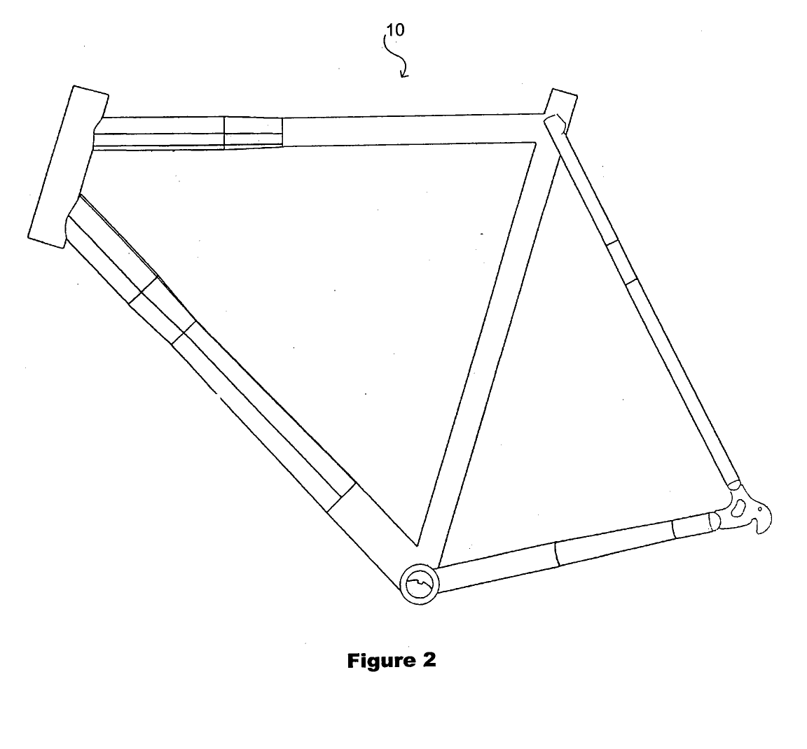

Referring now to FIG. 2 a standard welded bicycle frame 10 is shown. The bicycle frame 10 comprises lugs as described in connection with FIG. 1, however the tubes comprise a metal or a metal alloy rendering bicycle frame 10 heavier than bicycle frame 100.

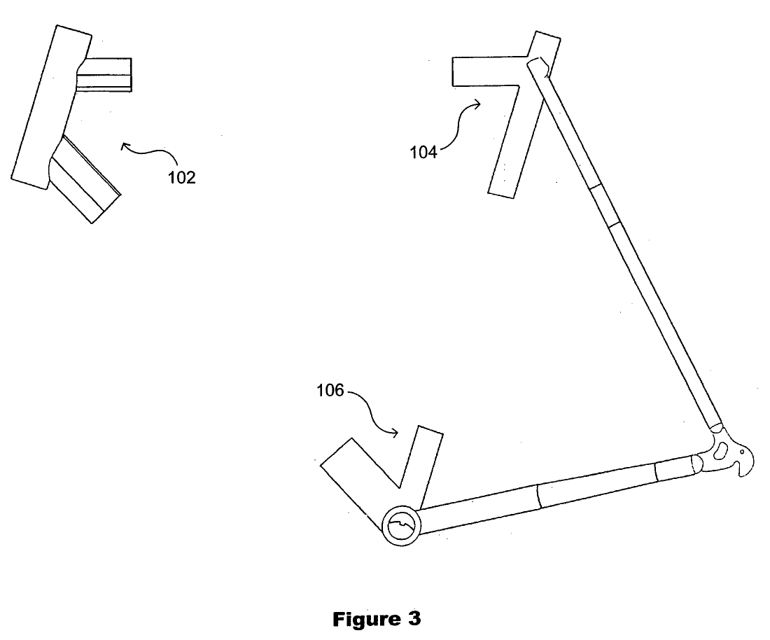

FIG. 3 shows the bicycle frame 10 according to FIG. 2 but with the tubes removed leaving only head lug 102, seat lug 104 and lower lug 106 in spatial relation to each other. These lugs may then be positioned relative to each other for full customization of the bicycle frame. In one advantageous embodiment the bicycle frame is divided up into multiple portions where for instance, a first portion may comprise head lug 102, a second portion may comprise seat lug 104 and a third portion may comprise lower lug 106.

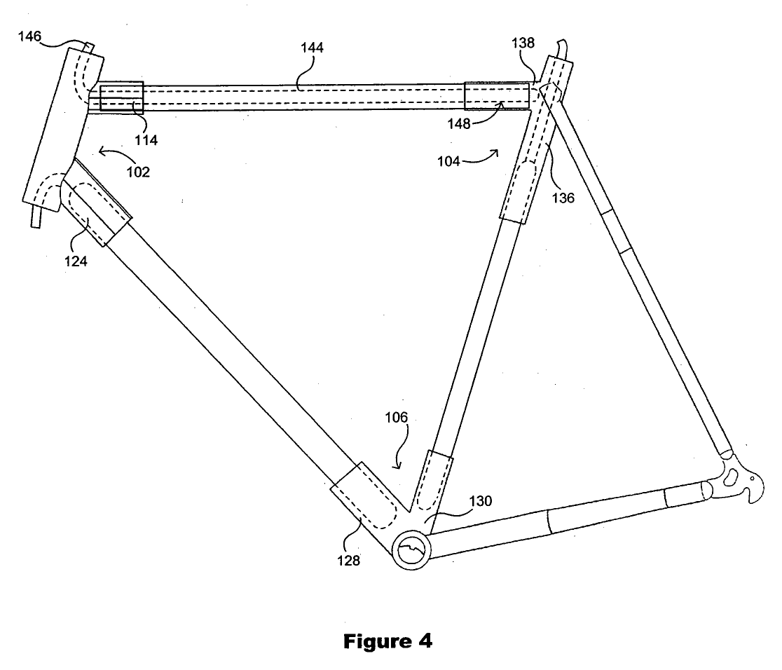

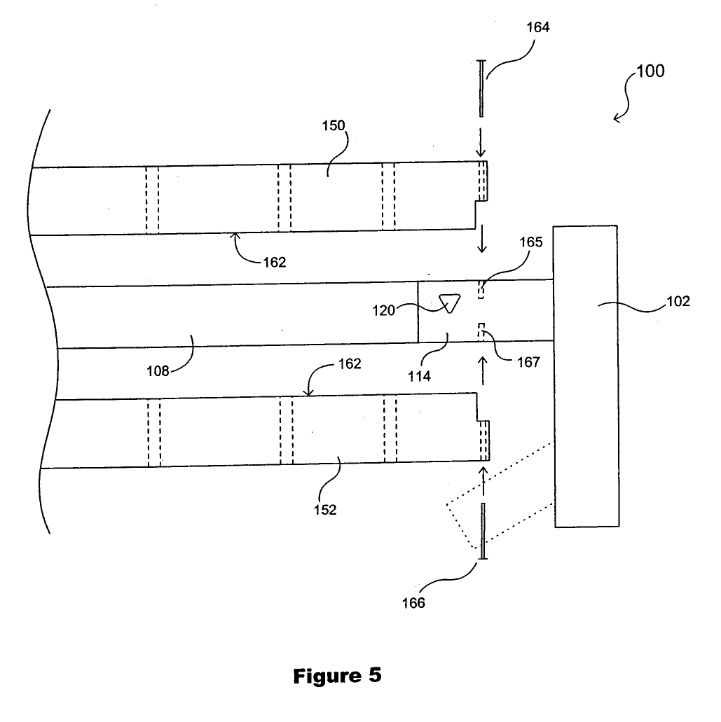

FIG. 4 illustrates the insertion of composite material that may on one advantageous embodiment comprise a pre-impregnated material, which will serve as top tube 108, down tube 110 and seat tube 112. In one advantageous embodiment, bladder molding carbon fiber/epoxy pre-impregnated material may be provided with unidirectional and bias plies formed from pre-impregnated fabric. These pieces of pre-impregnated carbon fiber may be rolled onto for instance, a bladder 144, assembled into the lugs, and then molded, which may involve raising the temperature of the pre-impregnated material. In practice, the composite pre-impregnated material may advantageously comprise only a few standard lengths thereby reducing the need to stock many differing sized pre-impregnated material units. Full customization of bicycle frame 100 is achieved by the pre-impregnated material being inserted into the sleeves of the respective lugs to a desired depth depending upon the customized size of bicycle frame 100 for the user. For instance, once a custom size is determined, a mold (FIGS. 5 & 6) is positioned about and attached to the lugs. Once so positioned, the pre-impregnated material may then be cut or trimmed to the desired length relative to the mold and the lugs. In this manner a standard length pre-impregnated material may be utilized to manufacture a fully customizable bicycle frame.

A bladder 144 illustrated as a dashed line inside of the pre-impregnated material connecting head lug 102 to seat lug 104 is positioned inside of the composite pre-impregnated material for later expansion of the pre-impregnated material. The bladder can be sealed and inflated in a number of different ways such as is disclosed in U.S. Pat. Nos. 4,889,355; 4,900,050, and 5,803,476 which are incorporated herein by reference. A neck 146 extends from the end of bladder 144 through opening 116 and exits from head lug 102 for later attachment to a source of pressurized air for expansion of bladder 144, which will cause the pre-impregnated material to expand.

Still further, an adhesive 148 may in one advantageous embodiment, be used to affix the composite material to the lug in a fixed desired position until the composite material is expanded into a permanent position relative to the lug. The adhesive 148 may comprise a thin epoxy film adhesive that is cut and adhered to the inside of the lugs before the composite material is inserted and then co-molded.

FIG. 5 is a side view of bicycle frame 100 and the attachment of molds 150, 152 for molding of the composite material that will become top tube 108. The molds are designed to enclose the various composite material prior to application of heat and expansion of the bladders. While the following description references top tube 108, head lug 102 and molds 150, 152, the description equally applies to each of the tubes, lugs and molds. Referring to molds 150, 152 for the molding of top tube 108, molds 150, 152 are provided with an inner surface 162 formed to shape top tube 108. In one advantageous embodiment inner surface 162 is partially cylindrical and partially oblong shaped toward head lug 102. However it is contemplated that many differing tube shapes may be desired depending upon the application and use.

The molds comprise any suitable material that may withstand the relatively high temperatures applied to the composite material such that they become pliable for expansion such that they may take on the shape of inner surface 162. In addition, molds 150, 152 are provided such that they may be secured to each other so as to be securely held to bicycle frame 100 during the molding process. In addition, attachment devices 164, 166 (in this case insertable tooling pins) associated with for instance, molds 150, 152 respectively are also provided to firmly affix molds 150, 152 to head lug 102 during the molding process. Attachment devices 164, 166 allow great versatility in the placement of the molds relative to the lugs because mounting holes 165, 167 respectively may be cut into the lug at virtually any location along the length of sleeve 114 as desired. In addition, once molds 150, 152 are positioned on sleeve 144, the composite material may be cut to the desired length. While FIG. 5 depicts hole 120 located in sleeve 114, this illustrates only one advantageous embodiment.

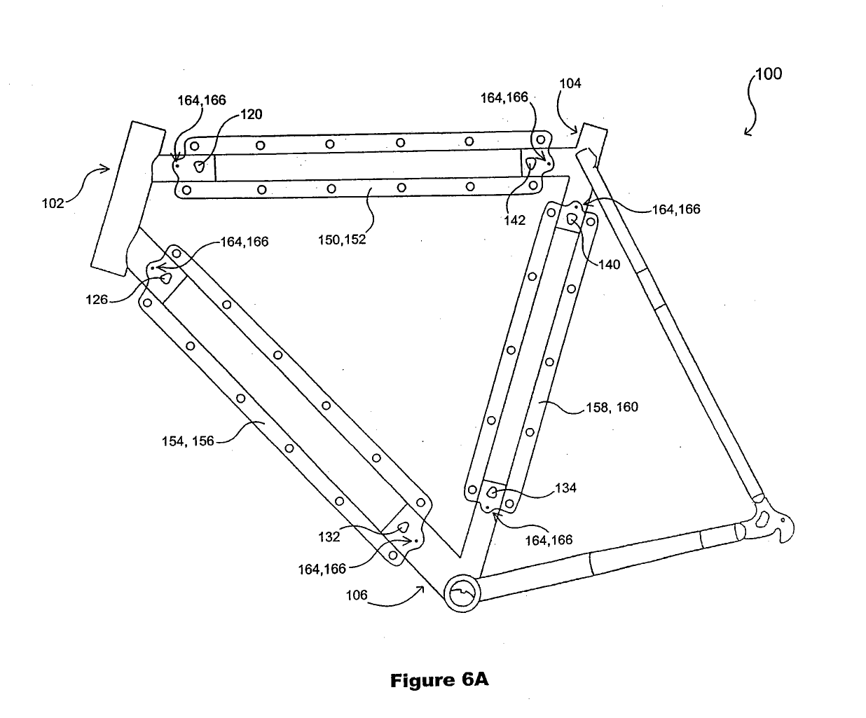

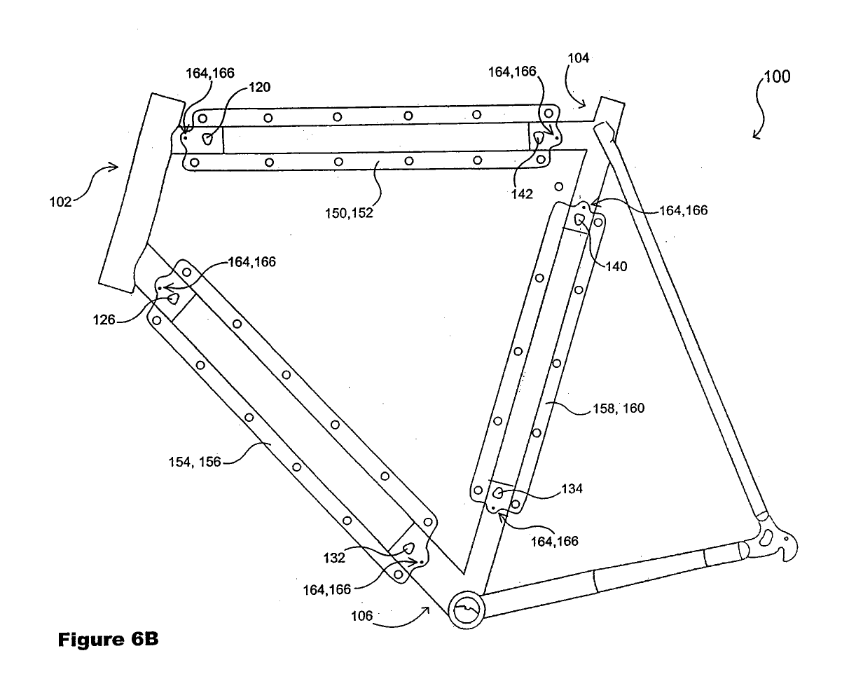

As can be seen from FIGS. 6A and 6B, the same molds may be utilized for differing sized bicycle frames due to the versatility of the various attachment devices such as 164, 166. The lugs may be positioned in the molds in a fixed spatial relationship relative to each other such that bicycle frame 100 is easily customizable for the user without the requirement of stocking large quantities of different sized molds and tooling. For instance, attachment devices 164, 166 may be inserted substantially anywhere along the sleeve portions of the lugs to adjust the size of the bicycle frame while using the same mold as can be seen in FIGS. 6A and 6B. The composite material is simply trimmed or cut to any desired length based upon the selected distance between the lugs. FIG. 6A is a smaller sized bicycle frame than FIG. 6B but uses the same sized molds for fabrication. In one advantageous embodiment, it is determined where the lugs will be positioned relative to each other and holes are cut into the lug for insertion of the associated attachment device relative to the lug. The hole 188 may be cut into the lug by any suitable means such as for instance, laser or mechanical cutting.

As illustrated in FIGS. 5, 6A and 6B, the molds are paired and affix to each other to fully enclose the composite material and at least a portion of the sleeve protruding from the associated lug. The molds would at least extend over the sleeve to enclose the holes such that the composite material does not escape through the holes during the molding process. The molds are still further affixed to bicycle frame 100 via attachment devices 164, 166 such that the molds to not move relative to the composite material that will become the tubes or the lugs during the molding process.

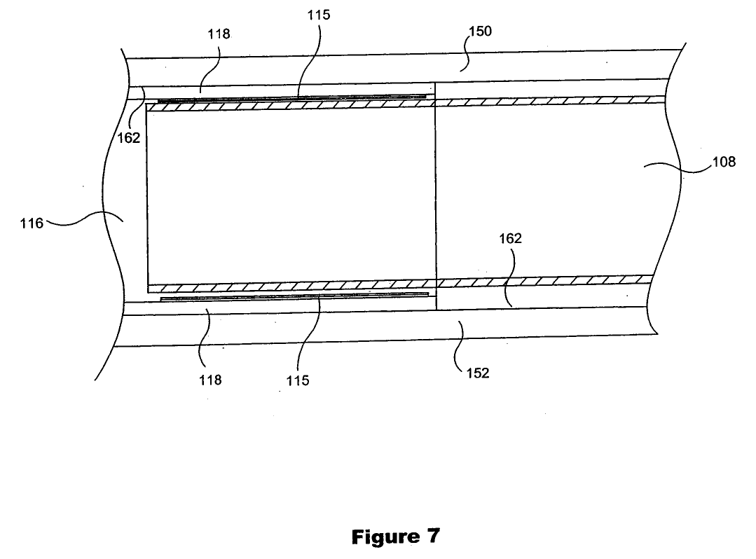

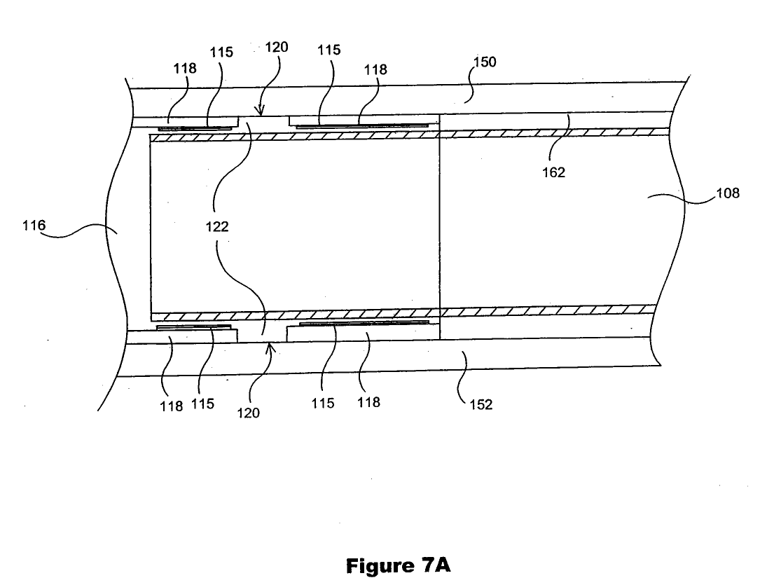

FIGS. 7 and 7A are side views of sleeve 114 per FIG. 6A with the composite material that will be top tube 108 inserted into opening 116 prior to expansion with molds 150, 152 attached around the composite material and sleeve 114. FIG. 7 shows the composite material that will become top tube 108 inserted into sleeve 114 with adhesive 115 extending along a portion of the length of the composite material inserted into sleeve 114. As can be seen in FIG. 7A, the end of the composite material that will become top tube 108 is inserted past hole 120 so that upon expansion of the composite material, a portion of the composite material will fill into the cavity. While adhesive 115 is shown extending along a length of sleeve 114, adhesive 115 may extend continuously or may be applied at one or more locations along the length of sleeve 114. The depth of insertion of the composite material is adjustable inside the sleeve 114 of head lug 102 to increase or decrease the distance of the lugs relative to each other.

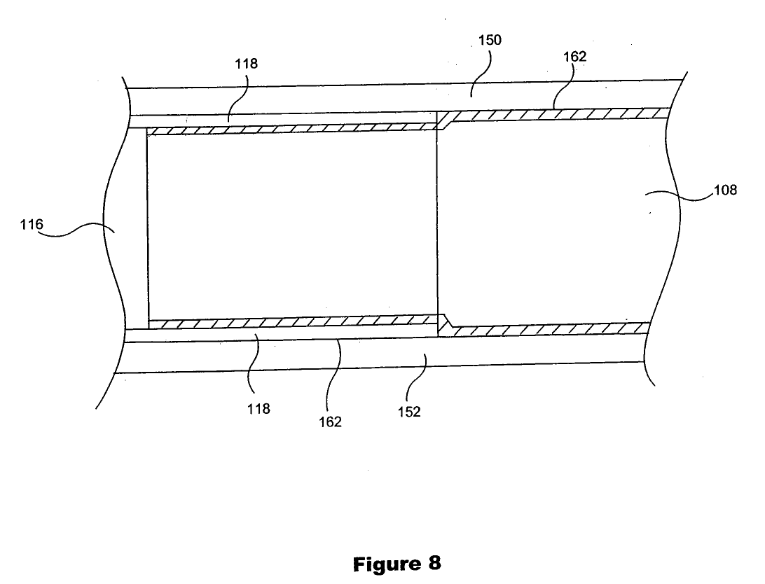

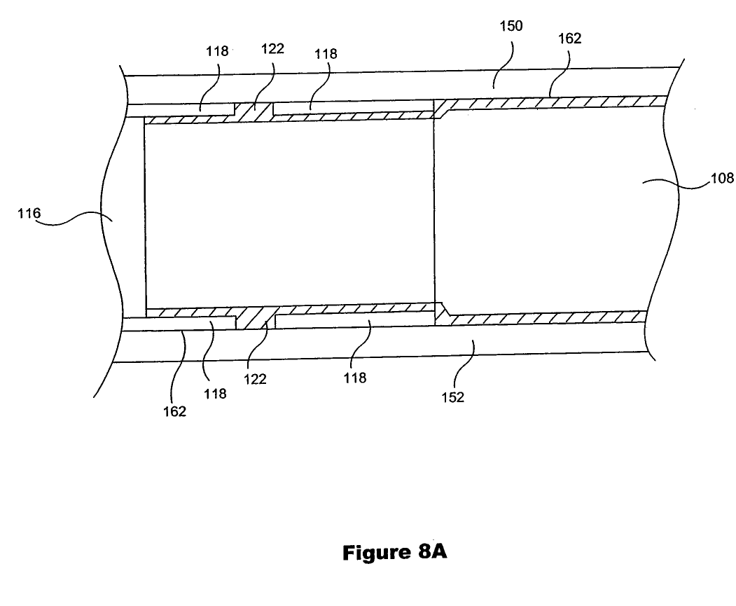

FIGS. 8 & 8A are side views according to FIGS. 7 & 7A showing the composite material expanded to fill the space between the composite material and inner wall 162, the inner wall of sleeve 114, and into hole 120 as illustrated in FIG. 7A. The composite material expands to fill the space in sleeve 114 coming into contact with adhesive 115 forming a bond between the composite material and the lug. In addition, in FIG. 8A the composite material also flows into hole 120 and upon cooling, creates a further interlock comprising protrusion 122 co-acting with hole 120. Once the composite material has cooled and hardened, molds 150, 152 may be removed to reveal the top tube 108 and head lug 102 assembly as illustrated in FIGS. 9 & 9A respectively.

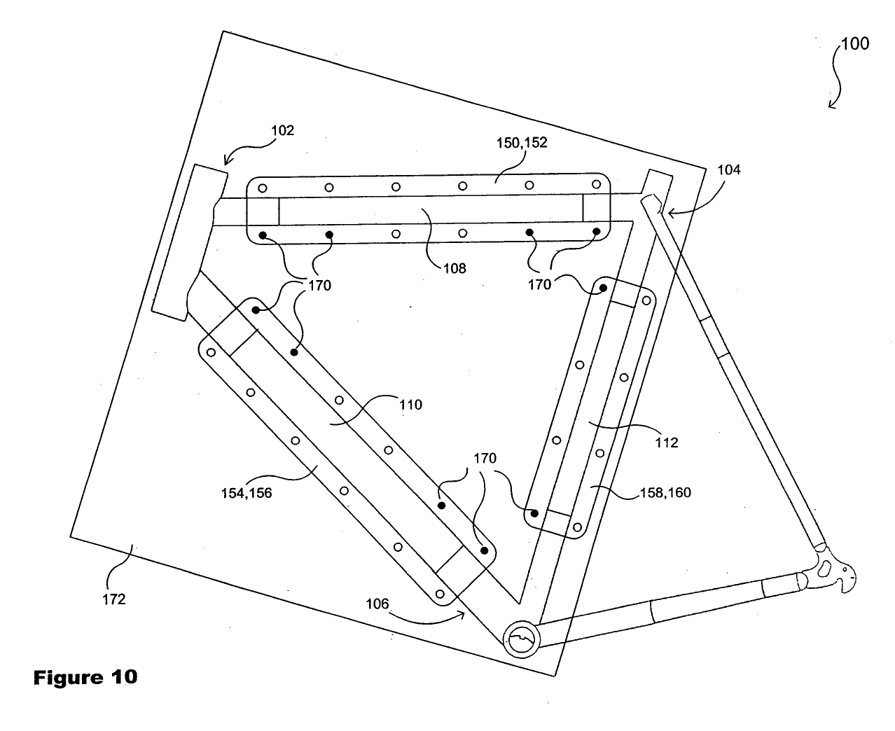

As an alternative to the use of the attachment devices to hold the molds in a fixed position relative to the lugs as previously described, another advantageous method may utilized according to FIG. 10. Here the molds are held in fixed spatial relationship relative to each other by means of insertable molding pins 170 (shown inserted into to plate 172) which attach the molds to plate 172. While molds 150, 152 and molds 154, 156 are each illustrated with four molding pins 170 for attachment to plate 172 and molds 158, 160 are shown with two molding pins 170 for attachment to plate 172, it is contemplated that any number of molding pins may effectively be used to hold the molds in fixed spatial relationship relative to each other.

This system and method of manufacture provides for a quick and inexpensive way to fabricate the bicycle frame 100 according to the invention. In addition, this method of manufacture be even be preferred for fabrication of more common sized bicycle frames as the need to cut holes for the attachment devices is eliminated. In addition, standard sized composite material may still be effectively utilize as once the lugs are positioned in the molds relative to each other, the composite material may then simply be cut to any desired length for connection between the lugs.

Although the invention has been described with reference to particular ingredients and formulations and the like, these are not intended to exhaust all possible arrangements or features, and indeed many other modifications and variations will be ascertainable to those of skill in the art.

I claim:

1. A system for fabricating a bicycle frame comprising:
a mold body having an inner molding surface;
a first portion at least partially in contact with said inner molding surface;
a second portion at least partially in contact with said inner molding surface;
an attachment device for connecting at least one of said first and second portions to one of multiple positions in said mold body to size the bicycle frame; and
a composite material placed within the mold body between and within at least a part of the first and second portions.

2. The system according to claim 1 wherein said attachment device comprises a pin insertable into a tooling hole provided in at least one of the first and second portions.

3. The system according to claim 2 further comprising at least a first molding hole positioned in said mold body.

4. The system according to claim 3 wherein upon the expanding of a bladder located within the composite material, the composite material adheres at least to said first portion.

5. A method for fabricating a bicycle frame comprising the steps of:
providing a mold body having an inner molding surface;
providing a first portion at least partially in contact with the inner molding surface;
providing a second portion at least partially in contact with the inner molding surface;
providing an attachment device for connecting at least one of said first and second portions to one of multiple positions in said mold body to size the bicycle frame; and
providing a composite material placed within the mold body between and within at least a part of the first and second portions.

6. The method according to claim 5 wherein said attachment device comprises a pin insertable into a tooling hole provided in at least one of the first and second portions.

7. The method according to claim 5 further comprising the step of positioning at least a first molding hole in the mold body.

8. The system according to claim 7 wherein upon the expanding of a bladder located within the composite material, the composite material adheres at least to the first portion.

9. A method for fabricating a bicycle frame comprising the steps of:
cutting a composite material to a desired length;
inserting the composite material into an end of a first portion;
positioning an adhesive layer between an inner surface of the first portion and the composite material; and
adhering the composite material to the first portion such that the adhesive layer is sandwiched between the composite material and the inner surface of the first portion.

10. The method according to claim 9 further comprising the step of positioning a hole in the first portion.

11. The method according to claim 10 further comprising the step of forming a protrusion from the composite material in the hole to interlock the first portion with the composite material.

12. The method according to claim 9 wherein the composite material is pre-impregnated with resin.

13. The method according to claim 9 wherein the composite material comprises structural fibers and resin.

14. The method according to claim 13 wherein the structural fiber is selected from the group consisting of carbon fibers, glass fibers, polyethylene fibers, or combinations thereof.

15. The method according to claim 9 wherein the first portion comprises a bicycle frame lug.

16. The method according to claim 9 wherein the step of adhering the composite material to the first portion includes forcing air into a bladder positioned inside of the composite material.

17. A system for fabricating a bicycle frame comprising:
a mold body having an inner molding surface;
a composite material placed within the mold body and at least partly within a frame portion the inner molding surface encasing both the composite material and at least a part of the frame portion; and
an attachment device for connecting said frame portion to one of multiple positions in said mold body to size the bicycle frame.

18. The system according to claim 17 wherein said attachment device comprises a pin insertable into a tooling hole provided in the frame portion.

19. A method for manufacturing a bicycle frame comprising the steps of:
providing a first portion;
providing a second portion;
extending a composite material between said first and second portions, the composite material sized according to a preferred distance between the first and second portions; and
positioning an adhesive layer between an inner surface of at least the first portion and the composite material to adhere the composite material to at least the first portion.

20. The method according to claim 19 further comprising the step of locating a hole in the first portion.

21. The method according to claim 20 further comprising the step of locating a protrusion in the hole, the protrusion being formed from the composite material and interlocking the first portion with the composite material.

22. The method according to claim 19 wherein the composite material is pre-impregnated with resin.

23. The method according to claim 19 wherein the composite material comprises structural fibers and resin.

24. The method according to claim 23 wherein the structural fiber is selected from the group consisting of carbon fibers, glass fibers, polyethylene fibers, or combinations thereof.

25. The method according to claim 19 wherein said first and said second portions comprise bicycle frame lugs.
